(19) United States
(12) Patent Application Publication
(10) Pub. No.: US 2020/0125111 A1
(43) Pub. Date: Apr. 23, 2020

(54) MOVING BODY CONTROL APPARATUS

(71) Applicants: Kabushiki Kaisha Toshiba, Tokyo (JP); Toshiba Electronic Devices & Storage Corporation, Tokyo (JP)

(72) Inventor: Kei Takizawa, Kawasaki Kanagawa (JP)

(21) Appl. No.: 16/298,583

(22) Filed: Mar. 11, 2019

(30) Foreign Application Priority Data
Oct. 19, 2018 (JP) 2018-197593

(51) Int. Cl. G05D 1/02; G06K 9/00; G08G 1/16; B60W 30/08

(52) U.S. Cl. CPC G05D 1/0238; G06K 9/00335; B60W 30/08; G08G 1/165; G08G 1/166; G06K 9/00805

(57) ABSTRACT

A moving body control apparatus of an embodiment is a moving body control apparatus including an image processing device configured to estimate a camera attitude on the basis of a photographed image obtained by a camera provided on a moving body and to output the camera attitude as an estimation result and a power control portion configured to control a power portion provided on the moving body on the basis of the estimation result, in which the image processing device includes a reliability feature amount calculating portion configured to calculate a reliability feature amount of the estimation result and a reliability determining portion configured to determine reliability of the estimation result on the basis of the reliability feature amount, and the power control portion determines whether automatic control of the power portion is executed or not on the basis of a determination result of the reliability.

### CROSS-REFERENCE TO RELATED APPLICATION

This application is based upon and claims the benefit of priority from the prior Japanese Patent Application No. 2018-197593 filed on Oct. 19, 2018; the entire contents of which are incorporated herein by reference.

### FIELD

Embodiments herein relate generally to a moving body control apparatus.

### BACKGROUND

In recent years, a system (safe driving system) in which a stereo camera is mounted on a moving body, such as a vehicle, to detect an obstacle on the basis of images outputted at a certain interval from the camera, and automatic control related to running of the vehicle so as to avoid contact with the obstacle is executed for supporting the driving has been put into practical use.

When the moving body is to be controlled by using such safe driving system, in estimating an attitude of a stereo camera, calculation of an estimation result with high reliability and at a high speed is important.

### BRIEF DESCRIPTION OF THE DRAWINGS

FIG. 1 is a view illustrating an example of a moving body 100 according to an embodiment;

FIG. 2 is a block diagram illustrating an example of configuration of the moving body 100 including a moving body control apparatus according to the embodiment;

FIG. 3 is a block diagram illustrating an example of an image processing device 10 mounted on the moving body 100;

FIG. 4 is a schematic block diagram illustrating an example of configuration according to the moving body control apparatus in the image processing device 10;

FIG. 5 is a flowchart for explaining an example of a determining procedure on whether the moving body automatic control according to the embodiment should be continued or not;

FIG. 6 is a flowchart for explaining a series of procedures of estimation of camera attitude/point three-dimensional coordinates in the image processing device;

FIG. 7 is a flowchart for explaining a series of procedures of motion estimation 2 according to a first embodiment;

FIG. 8A is a diagram for explaining block matching of image used for reliability evaluation of an estimation result;

FIG. 8B is a diagram for explaining the block matching of image used for the reliability evaluation of the estimation result;

FIG. 9A is a view for explaining a reliability evaluating method of the estimation result;

FIG. 9B is a view for explaining the reliability evaluating method of the estimation result;

FIG. 10 is a view for explaining the reliability evaluating method of the estimation result;

FIG. 11 is a flowchart for explaining another procedure of the motion estimation 2 according to the first embodiment;

FIG. 12 is a flowchart for explaining a series of procedures of the motion estimation 2 according to a variation of the first embodiment;

FIG. 13 is a flowchart for explaining another procedure of the motion estimation 2 according to the variation of the first embodiment;

FIG. 14 is a flowchart for explaining a series of procedures of the motion estimation 2 according to a second embodiment;

FIG. 15 is a flowchart for explaining another procedure of the motion estimation 2 according to the second embodiment;

FIG. 16 is a flowchart for explaining a series of procedures of the motion estimation 2 according to a third embodiment; and

FIG. 17 is a flowchart for explaining another procedure of the motion estimation 2 according to the third embodiment.

### DETAILED DESCRIPTION

A moving body control apparatus of the embodiment is a moving body control apparatus including an image processing device configured to estimate an attitude of an image pickup device on the basis of a photographed image obtained by the image pickup device provided on a moving body and to output the attitude as an estimation result and a power control portion configured to control a power portion provided on the moving body on the basis of the estimation result, in which the image processing device includes a reliability feature amount calculating portion configured to calculate a reliability feature amount of the estimation result, and a reliability determining portion configured to determine reliability of the estimation result on the basis of the reliability feature amount. Moreover, the power control portion determines whether automatic control of the power portion is executed or not on the basis of a determination result of the reliability.

The embodiments will be described below by referring to the drawings.

### First Embodiment

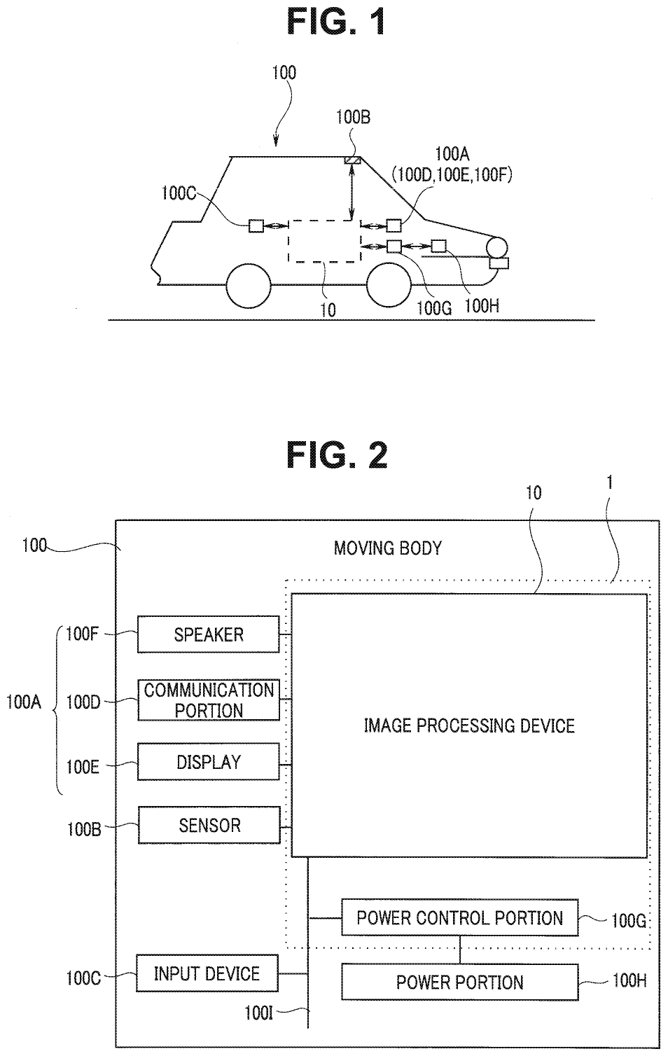

FIG. 1 is a view illustrating an example of a moving body 100 on which a moving body control apparatus according to the embodiment is mounted.

The moving body 100 includes an image processing device 10, an output portion 100A, a sensor 100B, an input device 100C, a power control portion 100G, and a power portion 100H.

The moving body 100 is a movable article. The moving body 100 is a vehicle (motorcycles, four-wheeled vehicles, bicycles), a cart, a robot, a boat, a flying object (aircrafts, unmanned aerial vehicles (UAV)), for example. The moving body 100 is a moving body running through a driving operation by a person and a moving body capable of automatic running (autonomous running) without through the driving operation by a person, for example. The moving body capable of autonomous running is an automatic drive vehicle, for example. With regard to the moving body 100 of the embodiment, a vehicle capable of autonomous running and also capable of driving operation by a person will be described as an example.

The output portion 100A outputs various types of information. The output portion 100A outputs output information by various types of processing, for example.

The output portion 100A includes a communication function of transmitting the output information, a display function of displaying the output information, a sound output function of outputting sound indicating the output information, for example. The output portion 100A includes a communication portion 100D, a display 100E, and a speaker 100F, for example.

The communication portion 100D communicates with an external device. The communication portion 100D is a VICS (registered trademark) communication circuit or a dynamic map communication circuit. The communication portion 100D transmits the output information to the external device. Moreover, the communication portion 100D receives road information or the like from the external device. The road information is a signal, a traffic sign, a peripheral building, a road width of each lane, a lane centerline and the like. The road information may be stored in a memory 10b such as a RAM and a ROM provided in the image processing device or may be stored in a memory provided separately in the moving body.

The display 100E displays the output information. The display 100E is a well-known LCD (liquid crystal display), a projecting device, a light and the like. The speaker 100F outputs sounds indicating the output information.

The sensor 100B is a sensor configured to obtain a running environment of the moving body 100. The running environment is observation information of the moving body 100 and peripheral information of the moving body 100, for example. The sensor 100B is an external sensor or an internal sensor, for example.

The internal sensor is a sensor configured to observe the observation information. The observation information includes an accelerator of the moving body 100, a speed of the moving body 100, an angular speed (yaw-axis angular speed) of the moving body 100.

The internal sensor includes an inertial measurement unit (IMU), an acceleration sensor, a speed sensor, a rotary encoder, a yaw rate sensor and the like. The IMU observes the observation information including three-axis acceleration and three-axis angular speed of the moving body 100.

The external sensor observes the peripheral information of the moving body 100. The external sensor may be mounted on the moving body 100 or may be mounted outside the moving body 100 (on another moving body or an external device, for example).

The peripheral information is information indicating a situation of the periphery of the moving body 100. The periphery of the moving body 100 is a region within a range from the moving body 100 determined in advance. The range is a range which can be observed by the external sensor. The range may be set in advance.

The peripheral information includes photographed images and distance information in the periphery of the moving body 100, for example. Note that the peripheral information may include position information of the moving body 100. The photographed images are photographed image data obtained by photographing (hereinafter called simply as photographed images in some cases). The distance information is information indicating a distance from the moving body 100 to a target. The target is a spot which can be observed by the external sensor in the external field. The position information may be a relative position or may be an absolute position.

The external sensor is a photographing device (camera) configured to obtain a photographed image by photographing, a distance sensor (millimetric wave radar, laser sensor, distance image sensor), a position sensor (GNSS (global navigation satellite system), GPS (global positioning system), wireless communication device) and the like.

The photographed image is digital image data specifying a pixel value for each pixel, a depth map specifying a distance from the sensor 100B for each pixel and the like. The laser sensor is a two-dimensional LIDAR (laser imaging detection and ranging) sensor installed in parallel with a horizontal surface and a three-dimensional LIDAR sensor, for example.

The input device 100C receives various instructions and information inputs from a user. The input device 100C is a pointing device such as mouse and a track ball or an input device such as a keyboard. The input device 100C may be an input function on a touch panel provided integrally with the display 100E.

The power control portion 100G controls the power portion 100H. The power portion 100H is a device mounted on the moving body 100 and configured to drive. The power portion 100H is an engine, a motor, a wheel and the like.

The power portion 100H is driven by control of the power control portion 100G. The moving body 100 of the embodiment is capable of autonomous running and thus, the power control portion 100G determines the situation of the periphery on the basis of the output information generated by the image processing device 1 and the information obtained from the sensor 100B and executes control of an accelerator amount, a brake amount, a steering angle and the like. That is, if an obstacle detected on the front of the moving body 100 is likely to collide against the moving body 100, the power portion 100H is controlled so as to avoid contact between the moving body 100 and the obstacle.

Subsequently, electric configuration of the moving body 100 will be described in detail. FIG. 2 is a block diagram illustrating an example of the configuration of the moving body 100.

The moving body 100 includes the image processing device 10, the output portion 100A, the sensor 100B, the input device 100C, the power control portion 100G, and the power portion 100H. The output portion 100A includes the communication portion 100D, the display 100E, and the speaker 100F as described above. The moving body control apparatus 1 of the embodiment is configured by including the image processing device 10 and the power control portion 100G.

The image processing device 10, the output portion 100A, the sensor 100B, the input device 100C, and the power control portion 100G are connected via a bus 100I. The power portion 100H is connected to the power control portion 100G.

Note that at least any one of the output portion 100A (communication portion 100D, display 100E, speaker 100F), the sensor 100B, the input device 100C, and the power control portion 100G needs to be connected to the image processing device 10 via wire or wirelessly. Moreover, at least any one of the output portion 100A (communication portion 100D, display 100E, speaker 100F), the sensor 100B, the input device 100C, and the power control portion 100G may be connected with the image processing device 10 via a network.

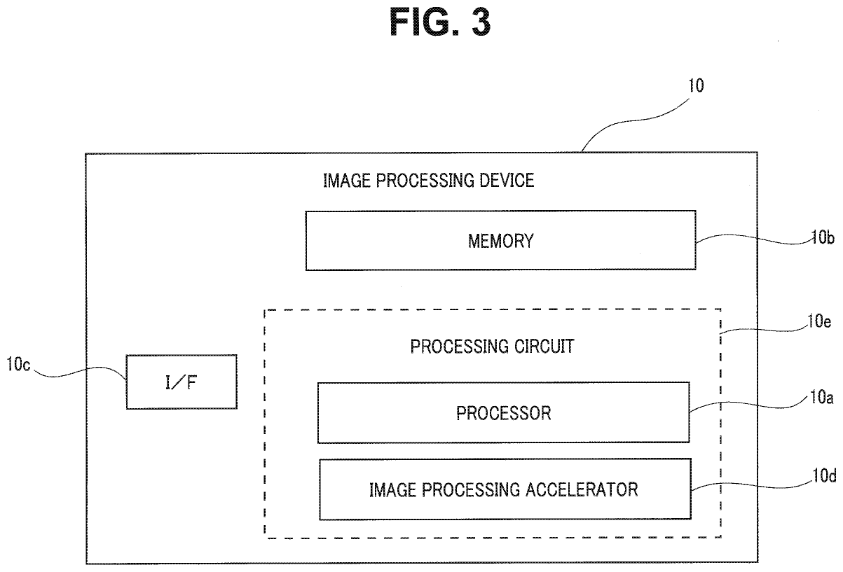

FIG. 3 is a block diagram illustrating an example of the image processing device 10 mounted on the moving body 100. The image processing device 10 includes an I/F 10c, a memory 10b, and a processor 10a.

The I/F 10c is connected to a network (N/W) with another system or the like. Moreover, the I/F 10c controls transmission/reception of the information with the communication portion 100D. The information of the recognized target such as a person and the information of the distance to the recognized target are outputted via the I/F 10c.

The memory 10b stores various types of data. The memory 10b is a semiconductor memory device such as a RAM (random access memory) and a flash memory, a hard disk, and an optical disk. Note that the memory 10b may be provided outside the image processing device 1. The ROM holds programs executed by the processor 10a and required data. The RAM functions as a work area for the processor 10a. Moreover, the memory 10b may be provided outside the moving body 100. The memory 10b may be disposed in a server device installed on a cloud, for example.

Moreover, the memory 10b may be a storage medium. More specifically, the storage medium may store or temporarily store the programs and various types of information by downloading them via a LAN (local area network) or the Internet. Moreover, the memory 10b may be constituted by a plurality of storage mediums.

Each of the processing functions in the processor 10a is stored in the memory 10b in a form of a program executable by a computer. The processor 10a is a processor configured to perform function portions corresponding to each program by reading and executing the program from the memory 10b.

Note that the processing circuit 10e may be configured by combining a plurality of independent processors for performing each of the functions. In this case, each of the functions is performed by execution of the program by each processor. Moreover, each of the processing functions may be configured as a program, and one processing circuit 10e may execute each program, or an image processing accelerator 10d may be provided as an exclusive circuit, and a specific function may be implemented on an independent program execution circuit.

The processor 10a performs the function by reading and executing the program stored in the memory 10b. Note that, instead of storing the program in the memory 10b, the program may be configured to be directly assembled in a circuit of the processor. In this case, the processor performs the function by reading and executing the program assembled in the circuit.

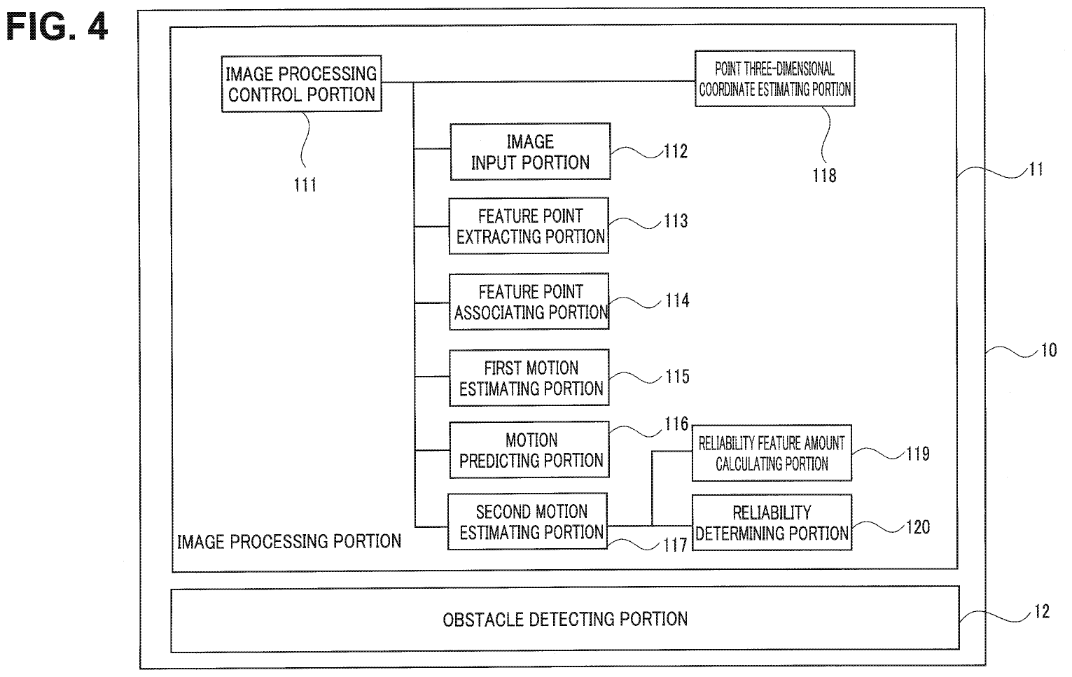

FIG. 4 is a schematic block diagram illustrating an example of the configuration of the image processing device 10. FIG. 4 illustrates only the configuration related to the moving body control apparatus. The image processing device 10 is configured by an image processing portion 11 and an obstacle detecting portion 12.

The image processing portion 11 estimates an attitude in a three-dimensional space in relation with a camera (hereinafter referred to as a camera attitude) included in the sensor 100B. Moreover, an obstacle on the front of the camera is extracted as a three-dimensional point group. The image processing portion 11 is configured by having an image processing control portion 111, an image input portion 112, a feature point associating portion 114, a first motion estimating portion 115, a motion predicting portion 116, a second motion estimating portion 117, a point three-dimensional coordinate estimating portion 118, a reliability feature amount calculating portion 119, and a reliability determining portion 120.

The obstacle detecting portion 12 detects an obstacle on the front of the camera on the basis of the camera attitude estimated by the image processing portion 11 and the extracted three-dimensional point group.

The image processing control portion 111 controls operations of the other constituent elements of the image processing portion 11 so that the three-dimensional point group is extracted by estimating the camera attitude.

The image input portion 112 obtains photographed images in a time series from the camera included in the sensor 100B. The photographed images in the time series are inputted at a constant time interval. In the following description, times when the photographed images are inputted are indicated by numbers such as 0, 1, 2, . . . , t−1, t, t+1, . . . in the order of input. Moreover, an input image at time t is called a frame t.

Note that an output from the image processing portion 11 is the camera attitude and the three-dimensional point group in the three-dimensional space at each time. The camera attitude at the time t is expressed by a six-dimensional vector indicated in Equation (1):

ξ^{(t)}=[ξ₀^{(t)}ξ₁^{(t)}ξ₂^{(t)}ξ₃^{(t)}ξ₄^{(t)}ξ₅^{(t)}]^{T} Equation (1)

This is a parameter expressing a translational motion and a rotary motion in the three-dimensional space and is known as Lie algebra se (3). Reference character ξ^{(t)} can be mutually converted to a pair of a rotation matrix and a translation vector in the three dimensions.

The feature point extracting portion 113 extracts a point with a strong edge or the like as a feature point from each frame obtained by the image input portion 112 by using an algorithm such as GFTT (good features to track).

The feature point associating portion 114 associates feature points of a frame t−1 and a frame t with each other. For the association, an ORB feature amount (Oriented FAST and Rotated BRIEF) is used.

The first motion estimating portion 115 estimates a relative attitude of the camera from a correspondence between the frame t−1 and the frame t. The estimation is made by using an algorithm disclosed in D. Nister, “An efficient solution to the five-point relative pose problem,” PAMI, 2004 (algorithm for estimating a relative attitude of a camera with two frames (a rotary motion and a translational motion in a three-dimensional space) from correspondence of five points or more between the two frames).

The motion predicting portion 116 predicts ξ^{(t)} with bar which is the camera attitude of the frame t from the camera attitude estimated in the past. The ξ^{(t)} with bar is expressed by a six-dimensional vector indicated in Equation (2):

ξ̅^{(t)}=[ξ̅₀^{(t)}ξ̅₁^{(t)}ξ̅₂^{(t)}ξ̅₃^{(t)}ξ̅₄^{(t)}ξ̅₅^{(t)}]^{T} Equation (2)

The ξ^{(t)} with bar which is a prediction value is used as an initial value of prediction in second motion estimation. The prediction of the ξ^{(t)} with bar is made by using the following Equation (3) from ξ^{(t-1)} with hat which is an estimated value of the camera attitude of the frame t−1 and ξ^{(t-2)} with hat which is an estimated value of the camera attitude of the frame t−2:

ξ̅^{(t)}=ξ̅^{(t-1)}+(ξ̅^{(t-1)}−ξ̅^{(t-2)}) Equation (3)

The point three-dimensional coordinate estimating portion 118 estimates three-dimensional coordinates of the feature point on the basis of each piece of the information on the camera attitude of the frame t−1 and the frame t, correspondence of the feature points between the frame t−1 and the frame t, coordinates of the feature point in the frame t−1 and the frame t on an input image. For estimation of the coordinates, general three-dimensional coordinate estimating method such as trigonometrical survey is used.

The second motion estimating portion 117 receives inputs of (1) three-dimensional point coordinates; (2) coordinates of a feature point of the frame t corresponding to the three-dimensional points; and (3) an initial value of the camera attitude of the frame t and outputs a motion estimation result of the frame t (estimated value of the camera attitude at the time t, ξ^{(t)} with hat). A specific calculating method of the estimated value of the camera attitude will be described in detail later.

The reliability feature amount calculating portion 119 calculates reliability of the motion estimation result calculated by the second motion estimating portion 117.

The reliability determining portion 120 compares a threshold value set in advance with the reliability calculated by the reliability feature amount calculating portion 119 and determines whether the motion estimation result is reliable or not.

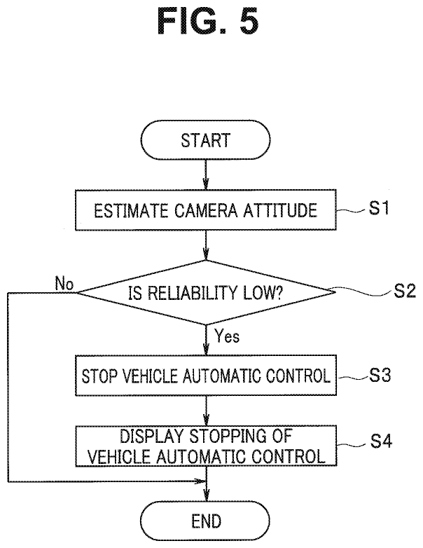

FIG. 5 is a flowchart for explaining an example of a determining procedure on whether the automatic control of the moving body according to the embodiment should be continued or not. First, in the image processing portion 11, the camera attitude is estimated (S1). Moreover, at S1, the reliability feature amount of the estimated camera attitude is calculated, and the estimated reliability of the camera attitude is determined in the reliability determining portion 120. If the estimated reliability of the camera attitude is determined to be low (the motion estimation result is not reliable) (S2, Yes), the power control portion 100G stops the vehicle automatic control (S3). Moreover, the image processing device 10 makes display on the display 100E that the vehicle automatic control has been stopped (S4).

On the other hand, if the estimated reliability of the camera attitude is determined not to be low (the motion estimation result is reliable) in the reliability determining portion 120 (S2, No), the power control portion 100G continues the vehicle automatic control.

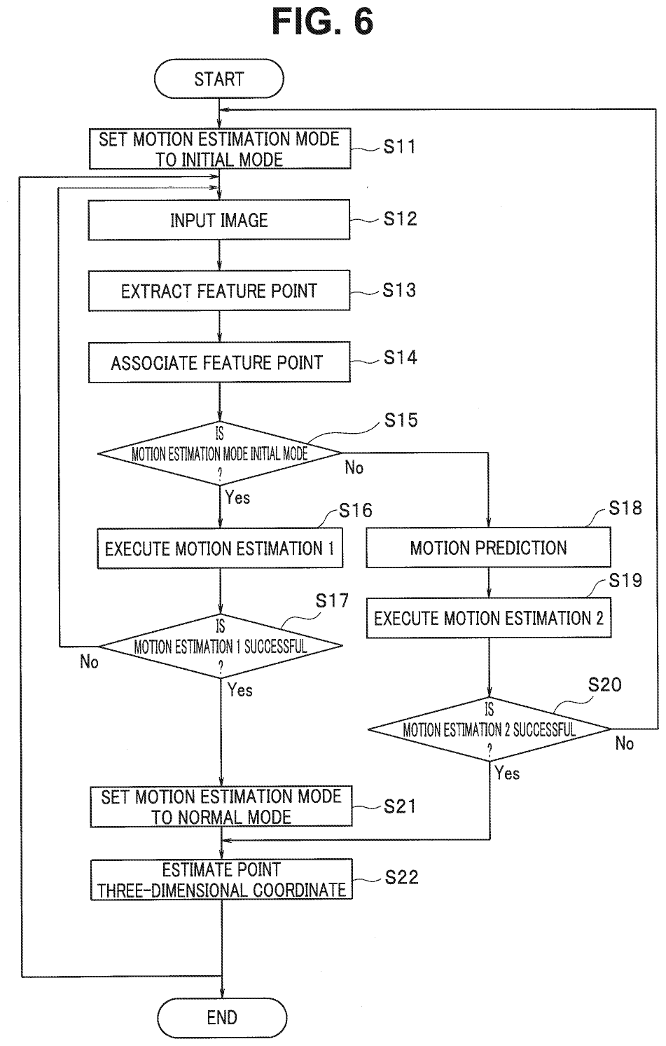

FIG. 6 is a flowchart for explaining a series of procedures of estimation of the camera attitude/point three-dimensional coordinates in the image processing device. First, the image processing control portion 111 sets a motion estimation mode to an “initial mode” (S11). In the image processing control portion 111, two motion estimation modes (“initial mode” and “normal mode”) according to a state where the estimation of the camera attitude is performed are registered. The modes use different motion estimating methods, respectively.

The “initial mode” is a mode corresponding to a state where the three-dimensional coordinate system on which the camera attitude is based is not determined, and estimation of the camera attitude is not performed, either. When the “initial mode” is set, the camera attitude is estimated in the first motion estimating portion 115. The “normal mode” is a mode corresponding to a state where the three-dimensional coordinate system on which the camera attitude is based is determined, and estimation of the camera attitude at the time t−1 has succeeded. When the “normal mode” is set, the estimation of the camera attitude is performed in the second motion estimating portion 117.

When setting of the motion estimation mode is completed, the image input portion 112 obtains a photographed image at the time t (frame t) from the camera of the sensor 100B (S12). Subsequently, the feature point extracting portion 113 extracts a point with a strong edge or the like as a feature point from the frame t (S13).

Subsequently, the feature point associating portion 114 associates the feature point extracted from the frame t with the feature point extracted at the previous frame (frame t−1) (S14). Subsequently, the image processing control portion 111 confirms whether the motion estimation mode is the “initial mode” or not (S15).

If the motion estimation mode is the “initial mode” (S15, Yes), the camera attitude is estimated in the first motion estimating portion 115 (S16, execution of motion estimation 1). In the motion estimation 1, the relative attitude of the camera is estimated from the correspondence between the frame t−1 and the frame t. If the relative attitude of the camera can be estimated by the motion estimation 1 (S17, Yes), the image processing control portion 111 sets the motion estimation mode to the “normal mode” (S21). Subsequently, in the point three-dimensional coordinate estimating portion 118, the three-dimensional coordinates of the feature point are estimated (S22), the routine returns to Step S12, the subsequent frame is obtained, and the camera attitude and the point three-dimensional coordinates are estimated.

On the other hand, if the relative attitude of the camera could not be estimated by the motion estimation 1 (S17, No), the routine returns to Step S12, the subsequent frame is obtained, and the motion estimation 1 is tried again.

At S15, if the motion estimation mode is the “normal mode” (S15, No), in the motion predicting portion 116, ξ^{(t)} with bar which is the camera attitude of the frame t is predicted from the camera attitude estimated in the past (S18).

Subsequently, in the second motion estimating portion 117, the camera attitude is estimated (S19, execution of motion estimation 2). In executing the motion estimation 2, into the second motion estimating portion 117, (1) the three-dimensional point coordinates; (2) the coordinates of the feature point of the frame t corresponding to the three-dimensional points; and (3) the initial value of the camera attitude of the frame t are inputted. The individual input items will be described below.

(1) Three-dimensional point coordinates: Three-dimensional coordinate points estimated by the point three-dimensional coordinate estimating portion 118 and indicating coordinates of a point associated with the feature point of the frame t. The three-dimensional point coordinates are expressed as the following Equation (4):

(Three-dimensional point coordinates)=[X_{g}⁽ⁱ⁾Y_{g}⁽ⁱ⁾Z_{g}⁽ⁱ⁾]^{T} (i=0, . . . , M−1) Equation (4)

Note that reference character M denotes the number of three-dimensional coordinates. Moreover, the superscript T expresses a transposed matrix.

(2) Coordinates of a feature point of the frame t corresponding to the three-dimensional points: Coordinates of the feature point of the frame t corresponding to the individual three-dimensional points. The coordinates of the feature point are expressed as the following Equation (5):

(Coordinates of a feature point of the frame t corresponding to the three-dimensional points)=[x_{obs}⁽ⁱ⁾y_{obs}⁽ⁱ⁾]^{T} (i=0 . . . M−1) Equation (5)

(3) Initial value of camera attitude of frame t: The camera attitude of the frame t predicted in the motion predicting portion 116 (ξ^{(t)} with bar, see Equation (2)).

The second motion estimating portion 117 executes the motion estimation 2 by using these inputs and calculates and outputs an estimated value (ξ^{(t)} with hat) of the camera attitude at the time t. Note that, (t) in the camera attitude ξ^{(t)} at the time t, the initial value (ξ^{(t)} with bar) of the camera attitude at the time t, the estimated value (ξ^{(t)} with hat) of the camera attitude at the time t is omitted in the following description as necessary and noted as ξ, ξ with bar, and ξ with hat, respectively.

In the motion estimation 2, ξ is estimated by using an algorithm for solving a problem of nonlinear least squares such as a Gaussian Newton's method and a Levenberg-Marquardt method. A parameter update equation when the Gaussian Newton's method is used will be described below.

In the motion estimation 2, ξ is estimated by using a projection error E (ξ) shown in the following Equation (6) as an objective function:

E(ξ)=Σᵢ₌₀^{M-1}[(xₚᵣⱼ⁽ⁱ⁾−x_{obs}⁽ⁱ⁾)²+(yₚᵣⱼ⁽ⁱ⁾−y_{obs}⁽ⁱ⁾)²] Equation (6)

Here, the projection coordinates in the frame t of a three-dimensional point i is expressed as in the following Equation (7):

(Projection coordinates in the frame t of a three-dimensional point i)=[xₚᵣⱼ⁽ⁱ⁾yₚᵣⱼ⁽ⁱ⁾]^{T} (t=0, . . . ,M−1) Equation (7)

The projection coordinates in the frame t of the three-dimensional point i is calculated by converting the three-dimensional point coordinates by using Equations (8) to (10):

$$\begin{matrix}[ \begin{matrix}{X}_{i}^{( i )} \\ {Y}_{i}^{( i )} \\ {Z}_{i}^{( i )}\end{matrix} ] = {R}_{ξ} [ \begin{matrix}{X}_{g}^{( i )} \\ {Y}_{g}^{( i )} \\ {Z}_{g}^{( i )}\end{matrix} ] + {T}_{ξ} & Equation ( 8 ) \\ {x}_{prj}^{( i )} = {f}_{x} \frac{{X}_{i}^{( i )}}{{Z}_{i}^{( i )}} & Equation ( 9 ) \\ {y}_{prj}^{( i )} = {f}_{x} \frac{{Y}_{i}^{( i )}}{{Z}_{i}^{( i )}} & Equation ( 10 )\end{matrix}$$

Note that, in Equation (8), it is assumed that R_{ξ} and T_{ξ} are a rotation vector and a translation vector, respectively, and are converted from ξ. Moreover, it is assumed that fₓ in Equation (9) is a focal distance in an x-direction, and f_{y} in Equation (10) is a focal distance in a y-axis direction.

In the Gaussian Newton's method, in parameter update by repeat calculation, an update amount Δξ is calculated by using the following Equation (11):

Δξ=−H⁻¹g^{T} Equation (11)

In Equation (11), g is a gradient vector of the projection error E and is expressed by the following Equation (12):

$$g = ∇ E = [ \begin{matrix}\frac{\partial E}{\partial {ξ}_{0}} & \frac{\partial E}{\partial {ξ}_{1}} & \frac{\partial E}{\partial {ξ}_{2}} & \frac{\partial E}{\partial {ξ}_{3}} & \frac{\partial E}{\partial {ξ}_{4}} & \frac{\partial E}{\partial {ξ}_{5}}\end{matrix} ] \qquad Equation ( 12 )$$

Moreover, in Equation (11), reference character H denotes Hessian matrices of the projection error E and it is expressed by the following Equation (13):

$$H = {∇}^{2} E = [ \begin{matrix}\frac{{\partial }^{2} E}{\partial {ξ}_{0}^{2}} & \frac{{\partial }^{2} E}{\partial {ξ}_{0} \partial {ξ}_{1}} & \frac{{\partial }^{2} E}{\partial {ξ}_{0} \partial {ξ}_{2}} & \frac{{\partial }^{2} E}{\partial {ξ}_{0} \partial {ξ}_{3}} & \frac{{\partial }^{2} E}{\partial {ξ}_{0} \partial {ξ}_{4}} & \frac{{\partial }^{2} E}{\partial {ξ}_{0} \partial {ξ}_{5}} \\ \frac{{\partial }^{2} E}{\partial {ξ}_{1} \partial {ξ}_{0}} & \frac{{\partial }^{2} E}{\partial {ξ}_{1}^{2}} & \frac{{\partial }^{2} E}{\partial {ξ}_{1} \partial {ξ}_{2}} & \frac{{\partial }^{2} E}{\partial {ξ}_{1} \partial {ξ}_{3}} & \frac{{\partial }^{2} E}{\partial {ξ}_{1} \partial {ξ}_{4}} & \frac{{\partial }^{2} E}{\partial {ξ}_{1} \partial {ξ}_{5}} \\ \frac{{\partial }^{2} E}{\partial {ξ}_{2} \partial {ξ}_{0}} & \frac{{\partial }^{2} E}{\partial {ξ}_{2} \partial {ξ}_{1}} & \frac{{\partial }^{2} E}{\partial {ξ}_{2}^{2}} & \frac{{\partial }^{2} E}{\partial {ξ}_{2} \partial {ξ}_{3}} & \frac{{\partial }^{2} E}{\partial {ξ}_{2} \partial {ξ}_{4}} & \frac{{\partial }^{2} E}{\partial {ξ}_{2} \partial {ξ}_{5}} \\ \frac{{\partial }^{2} E}{\partial {ξ}_{3} \partial {ξ}_{0}} & \frac{{\partial }^{2} E}{\partial {ξ}_{3} \partial {ξ}_{1}} & \frac{{\partial }^{2} E}{\partial {ξ}_{3} \partial {ξ}_{2}} & \frac{{\partial }^{2} E}{\partial {ξ}_{3}^{2}} & \frac{{\partial }^{2} E}{\partial {ξ}_{3} \partial {ξ}_{4}} & \frac{{\partial }^{2} E}{\partial {ξ}_{3} \partial {ξ}_{5}} \\ \frac{{\partial }^{2} E}{\partial {ξ}_{4} \partial {ξ}_{0}} & \frac{{\partial }^{2} E}{\partial {ξ}_{4} \partial {ξ}_{1}} & \frac{{\partial }^{2} E}{\partial {ξ}_{4} \partial {ξ}_{2}} & \frac{{\partial }^{2} E}{\partial {ξ}_{4} \partial {ξ}_{3}} & \frac{{\partial }^{2} E}{\partial {ξ}_{4}^{2}} & \frac{{\partial }^{2} E}{\partial {ξ}_{4} \partial {ξ}_{5}} \\ \frac{{\partial }^{2} E}{\partial {ξ}_{5} \partial {ξ}_{0}} & \frac{{\partial }^{2} E}{\partial {ξ}_{5} \partial {ξ}_{1}} & \frac{{\partial }^{2} E}{\partial {ξ}_{5} \partial {ξ}_{2}} & \frac{{\partial }^{2} E}{\partial {ξ}_{5} \partial {ξ}_{3}} & \frac{{\partial }^{2} E}{\partial {ξ}_{5} \partial {ξ}_{4}} & \frac{{\partial }^{2} E}{\partial {ξ}_{5}^{2}}\end{matrix} ] \qquad Equation ( 13 )$$

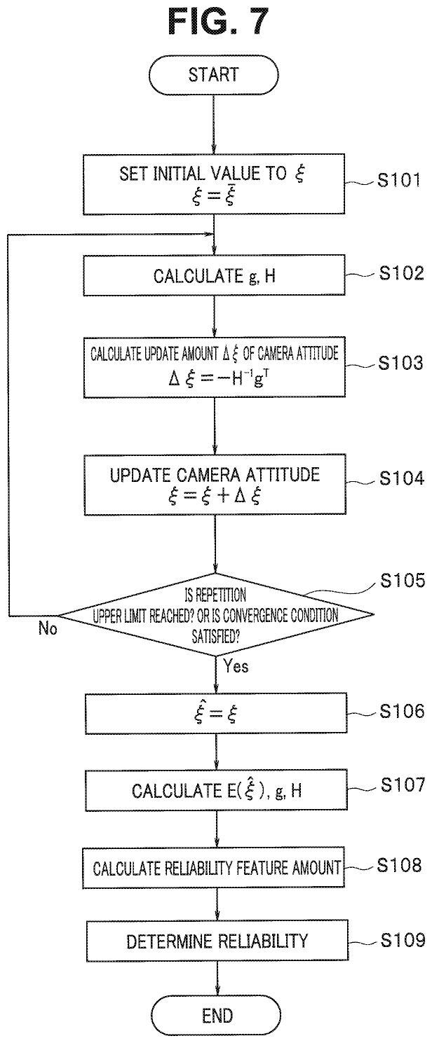

Subsequently, specific procedures of the motion estimation 2 (S19 in FIG. 6) will be described by using FIG. 7. FIG. 7 is a flowchart for explaining a series of procedures of the motion estimation 2 according to a first embodiment.

First, ξ with bar is substituted for ξ, and an initial value is set to ξ (S101). Subsequently, g and H are calculated by using Equation (12) and Equation (13), respectively (S102). Subsequently, g and H calculated at S102 is substituted in Equation (11), and the update amount Δξ of the camera attitude is calculated (S103). Subsequently, the camera attitude ξ is updated by using the update amount Δξ calculated at S103 (S104).

Subsequently, convergence determination of ξ is executed (S105). If the number of update times of ξ has reached a number of times set in advance or if a set convergence condition is satisfied (S105, Yes), parameter update processing is finished, and ξ at that point of time is made an estimation result (ξ with hat) (S106).

As the convergence condition at S105, the following Expression (14) or Expression (15) is used, for example:

$$\begin{matrix}\frac{E ( ξ )}{M} < {T}_{A} & Expression ( 14 ) \\ \frac{Δ ξ}{\vert ξ ‖} < {T}_{B} & Expression ( 15 )\end{matrix}$$

In Expressions (14) and (15), T_{A} and T_{B} are fixed threshold values set in advance. Expression (14) shows a determining equation when an average of the projection error per one three-dimensional point is less than a threshold value set in advance or not is determined. Moreover, Expression (15) shows a determining equation when a value obtained by dividing an update amount of a parameter which is an estimation target by a norm of an estimation parameter and by normalizing the result is less than the threshold value set in advance or not is determined.

If the number of update times of ξ has not reached the number of times set in advance and if the set convergence condition is not satisfied (S105, No), the routine returns to S102, and the parameter update processing is continued.

When the estimation result of the camera attitude (ξ with hat) is determined at S106, reliability of the estimation result is evaluated. For the reliability evaluation in the embodiment, an evaluating method of reliability of the estimation result in block matching of image is applied.

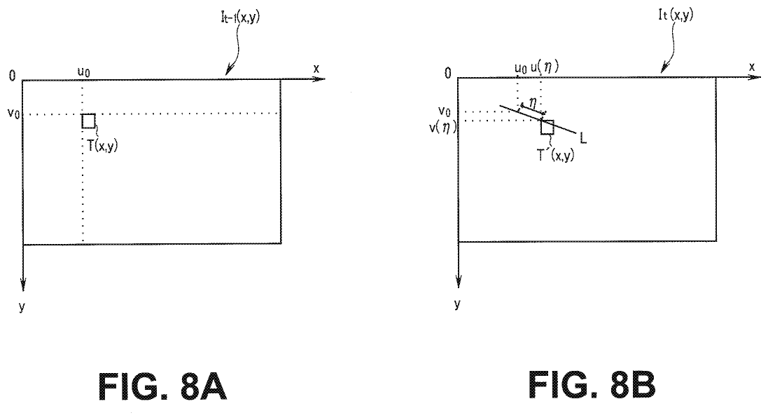

Here, a general evaluating method of reliability of the estimation result in the block matching of image will be described. FIGS. 8A and 8B are views for explaining the block matching of image used for the reliability evaluation of the estimation result. FIG. 8A shows an image 1ₜ₋₁ (x, y) at the time t−1, and FIG. 8B shows an image 1ₜ (x, y) at the time t. The block matching of the image is to search a block corresponding to a block T(x, y) in the image 1ₜ₋₁ (x, y) at the time t−1 from the image 1ₜ (x, y) at the time t.

Here, a width and a height of the block T(x, y) are assumed to be both N pixels, and (u₀, v₀) are assumed to be coordinates of upper left of T(x, y) in 1ₜ₋₁ (x, y). When search is made on a straight line L illustrated in FIG. 8B, normalized correlation between T(x, y) and a block T (x, y) located on the straight line L of 1ₜ (x, y) is calculated. The normalized correlation is calculated by the following Equation (16):

$$S ( η ) = \frac{{\sum }_{j = 0}^{N - 1} {\sum }_{i = 0}^{N - 1} [ {I}_{t - 1} ( i + {u}_{0} , j + {v}_{0} ) * {I}_{t} ( i + u ( η ) , j + v ( η ) ) ]}{\sqrt{\begin{matrix}{\sum }_{j = 0}^{N - 1} {\sum }_{i = 0}^{N - 1} {( i + {u}_{o} , j + {v}_{0} )}^{2} * \\ {\sum }_{j = 0}^{N - 1} {\sum }_{i = 0}^{N - 1} {{I}_{t} ( i + u ( η ) , j + v ( η ) )}^{2}\end{matrix}}} \qquad Equation ( 16 )$$

In Equation (16), (u(η), v(η)) are assumed to be coordinates of upper left of the block T(x, y) in 1ₜ (x, y). Moreover, η is a length from a point on upper left of T(x, y) to a point on upper left of T′(x, y) on the straight line L, and in the case of a position relationship illustrated in FIG. 8B, η is assumed to be positive. In the case of η=0, coordinates of upper left of T(x, y) are (u₀, v₀) and are matched with the coordinates of the upper left of T(x, y).

In the block matching, η at which S(η) is the maximum is an estimation result η with hat. At this time, the coordinates of the upper left of T′(x, y) corresponding to T(x, y) are (u(η with hat), v(η with hat)).

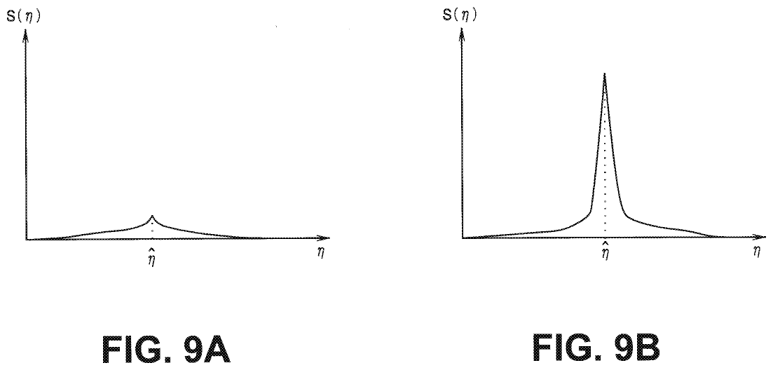

The evaluating method of reliability of the estimation result includes a method using steepness of S(η) in the periphery of the estimation result η with hat as a reliability index. That is, if S(η with hat) is remarkably larger than the periphery, reliability is determined to be high. FIGS. 9A and 9B are views for explaining the reliability evaluating method of the estimation result. The steepness in the vicinity of the estimation result η with hat is higher in S(η) illustrated in FIG. 9B than in S(η) illustrated in FIG. 9A. Therefore, the reliability is considered to be higher in S(η with hat) illustrated in FIG. 9B than in S(η with hat) illustrated in FIG. 9A.

When the reliability is calculated as a numeral value, a reliability feature amount cf (η with hat) can use the following Equation (17) or Equation (18), for example:

$$\begin{matrix}cf ( \hat{η} ) = \frac{S ( \hat{η} )}{{max}_{η ∈ υ ( η )} S ( \hat{η} )} & Equation ( 17 ) \\ cf ( \hat{η} ) = S ( \hat{η} ) - {max}_{η ∈ υ ( η )} S ( η ) & Equation ( 18 )\end{matrix}$$

In Equations (17) and (18), U(η with hat) is assumed to be a set of neighboring points of η with hat separated from η with hat by a certain distance. Equations (17) and (18) express how larger S(η with hat) corresponding to the estimation result η with hat is than the vicinity of η with hat. Equation (17) makes comparison using a ratio and Equation (18) makes comparison using a difference.

Assuming that U(η with hat) is a set shown in Equation (19), for example, Equation (17) becomes Equation (20), and Equation (18) can be expressed as Equation (21):

$$\begin{matrix}U ( \hat{η} ) = \{ \hat{η} + Δ η , \hat{η} - Δ η \} & Equation ( 19 ) \\ cf ( \hat{η} ) = \frac{S ( \hat{η} )}{max ( S ( \hat{η} + Δ η ) , S ( \hat{η} + Δ η ) )} & Equation ( 20 ) \\ cf ( \hat{η} ) = S ( \hat{η} ) - max ( S ( \hat{η} + Δ η ) , S ( \hat{η} + Δ η ) ) & Equation ( 21 )\end{matrix}$$

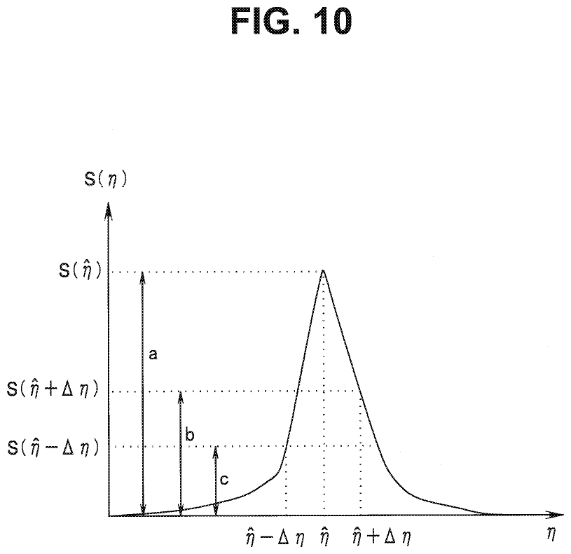

A specific calculating method of reliability using Equation (20) or Equation (21) will be described by using FIG. 10. FIG. 10 is a view for explaining a reliability evaluating method of an estimation result. In FIG. 10, values of S(η) for a lower limit and an upper limit of U(η with hat) are assumed to be b, c (b>c), respectively, and a value of S(η with hat) is assumed to be a. That is, each S(η) is assumed to be a value shown in the following Equations (22) to (24):

S(\hat{η}−Δη)=b Equation (22)

S(\hat{η}+Δη)=c Equation (23)

S(\hat{η})=a Equation (24)

In this case, Equation 20 becomes Equation (25) shown below:

$$cf ( \hat{η} ) = \frac{a}{max ( b , c )} = \frac{a}{b} \qquad Equation ( 25 )$$

Moreover, Equation (21) becomes Equation (26) shown below:

cf(η)=a−max(b,c)=a−b Equation (26)

When the general evaluating method of reliability of the estimation result in the aforementioned block matching of image is used for the reliability evaluation of the estimation result of the motion estimation 2 in the embodiment, Equation (17) or Equation (18) is modified considering the following differences:

A first point is that, in the case of the block matching of image, a parameter by which the objective function S(η) becomes the maximum is estimated, while in the motion estimation 2, a parameter by which the objective function E(ξ) becomes the minimum is estimated. Therefore, in the case of the block matching of image, a maximum value of a neighboring point is calculated, but a minimum value of the neighboring point is calculated in the motion estimation 2.

A second point is that, in the case of the block matching of image, the larger the objective function S (η with hat) in the estimated value is to the neighboring point, the higher the reliability is regarded to be, while in the motion estimation 2, the smaller the objective function E(ξ with hat) in the estimated value is than the neighboring point, the higher the reliability is regarded to be.

Therefore, when the reliability feature amount is to be calculated by using a ratio, the maximum value of the neighboring point is divided by the objective function S(η with hat) in the block matching of image, while the minimum value of the neighboring point is divided by the objective function E(ξ with hat) in the motion estimation 2. Moreover, when the reliability feature amount is to be calculated by using the difference, the maximum value of the neighboring point is subtracted from the objective function S(η with hat) in the block matching of image, while the objective function E(ξ with hat) is subtracted from the minimum value of the neighboring point in the motion estimation 2.

A third point is that, in the case of the block matching of image, a width and a height (=N) of the block T(x, y) are fixed values, while the number (=M) of the three-dimensional points used for projection error calculation is fluctuated with time in the motion estimation 2. Therefore, when the reliability feature amount is to be calculated by using a difference, in the motion estimation 2, in order to prevent dependence of the difference in the projection errors on M fluctuating with time, the difference between the minimum value of the neighboring point and the objective function E (ξ with hat) is divided by M.

An equation for calculating the reliability feature amount in the motion estimation 2 applying Equations (17) and (18) by considering the aforementioned three points can be the following Equations (27) and (28):

$$\begin{matrix}cf ( \hat{ξ} ) = \frac{{min}_{ξ ∈ υ ( ξ )} E ( ξ )}{E ( \hat{ξ} )} & Equation ( 27 ) \\ cf ( \hat{ξ} ) = \frac{{min}_{ξ ∈ υ ( ξ )} ( E ( \hat{ξ} ) ) - E ( \hat{ξ} )}{M} & Equation ( 28 )\end{matrix}$$

In Equations (27) and (28), U(ξ with hat) is assumed to be a set of neighboring points separated from with hat by a certain distance. For example, there can be a set sampling ξ satisfying the following Equation (29):

∥ξ−\hat{ξ}∥=d Equation (29)

Note that, in Equation (29), reference character d is assumed to be a constant. The reliability feature amount cf(ξ with hat) calculated by Equations (27) and (28) expresses how small E(ξ with hat) is as compared with a neighbor of ξ with hat. Equation (27) applied from Equation (17) uses a ratio for comparison. Equation (28) applies Equation (18) and uses a difference for comparison. In both Equations (27) and (28), the smaller E(ξ with hat) is than the neighbor of ξ with hat, the larger the reliability feature amount cf(ξ with hat) becomes.

In calculating the reliability feature amount cf(ξ with hat), the objective function E(ξ) needs to be calculated in the periphery of the estimation result ξ with hat, and Equations (6), (8), (9), and (10) should be calculated many times. Moreover, in the calculation of the objective function E(ξ), the larger the number M of the three-dimensional point becomes, the more the calculation amount increases. However, if the calculation of the reliability feature amount takes time, determination on whether the moving body automatic control should be continued or not is delayed and it is likely that the automatic control cannot be stopped in a timely manner. Thus, in the embodiment, in order to calculate the reliability feature amount cf(ξ with hat) at a high speed, as illustrated in Equation (30), the objective function E(ξ) is calculated in the periphery of the estimation result ξ with hat by using Taylor developing:

E(ξ+Δξ)≅E(ξ)+g^{T}Δξ+½Δξ^{T}HΔξ Equation (30)

Returning to the flowchart in FIG. 7, the reliability of the estimation result (ξ with hat) of the camera attitude determined at S106 is evaluated. The reliability feature amount used for the reliability evaluation is calculated by using Equation (27) or Equation (28). In either of the equations, when the objective function E(ξ) is to be calculated in the periphery of the estimation result ξ with hat, Equation (30) is used.

Thus, prior to the calculation of the reliability feature amount, E(ξ with hat), g, H are calculated (S107). Note that, E(ξ with hat) is calculated by using Equation (6), g by Equation (12), and H by Equation (13), respectively.

Subsequently, on the basis of a calculation result at S107, the reliability feature amount cf(ξ with hat) is calculated by using Equation (27) or Equation (28) (S108). At S108, when the objective function E(ξ) is calculated in the periphery of the estimation result ξ with hat, the reliability feature amount cf(ξ with hat) can be calculated at a high speed by using Equation (30).

Lastly, the reliability feature amount cf(ξ with hat) is compared with the threshold value T set in advance (S109). If the reliability feature amount cf(ξ with hat) is larger than the threshold value T, it is determined that ξ with hat which is the motion estimation result is reliable (reliability is high). On the other hand, if the reliability feature amount cf(ξ with hat) is not larger than the threshold value T, it is determined that ξ with hat which is the motion estimation result has low reliability.

The motion estimation result ξ with hat and the reliability determination result by the reliability feature amount cf(ξ with hat) are outputted, and the series of procedures of the motion estimation 2 illustrated in FIG. 7 is finished.

Returning to the flowchart in FIG. 6, if the motion estimation 2 is successful at S19 (S20, Yes), the routine goes on to S22, and the three-dimensional coordinates of the feature point are estimated in the point three-dimensional coordinate estimating portion 118. If the frame continues, the routine returns to Step S12, the subsequent frame is obtained, and the camera attitude and the point three-dimensional coordinates are estimated. On the other hand, if the motion estimation 2 fails at S19 (S20, No), the routine returns to S11, the motion estimation mode is set to the “initial mode”, and the series of procedures of the estimation of the camera attitude/point three-dimensional coordinates are repeated from the beginning.

As described above, according to the embodiment, whether the estimation result of the camera attitude in the motion estimation 2 is reliable or not is determined by calculating the reliability feature amount of the estimation result. When the reliability feature amount is to be acquired, E(ξ) in the neighborhood of with hat is calculated by using Taylor developing and thus, the estimation result with high reliability can be calculated at a high speed. Moreover, only when the reliability is determined to be high, the automatic control of the moving body is continued, while if the reliability is determined to be low, the automatic control of the moving body is stopped, and the stop of the automatic control is notified to a driver. Therefore, the driver can easily recognize that the driver should operate the moving body by himself/herself and thus, the moving body can be controlled more safely.

Note that, in the above, the example in which ξ is estimated by using the Gaussian Newton's method in the motion estimation 2 is described, but the algorithm used for the estimation of ξ only needs to be an algorithm which solves a problem of nonlinear least squares and is not limited to the Gaussian Newton's method. The Levenberg-Marquardt method may be used for estimating ξ, for example.

In the Levenberg-Marquardt method, in the parameter update in the repeat calculation, the update amount Δξ is calculated by using the following Equation (31):

Δξ=−(H*)⁻¹g^{T} Equation (31)

In Equation (31), H* is a matrix with a damping factor X added to a diagonal component of H and is expressed by the following Equation (32):

H*=H+λI Equation (32)

In Equation (32), reference character I denotes a unit matrix. Moreover, the damping factor λ sets a fixed value after start of processing and is updated in the repeat calculation.

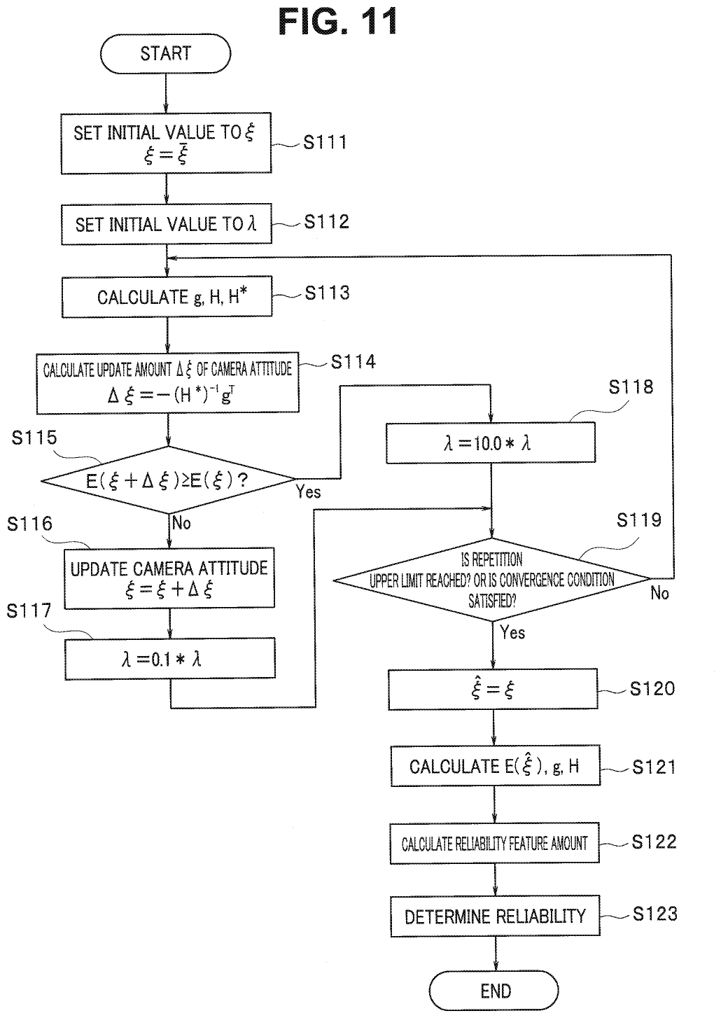

Hereinafter, a series of procedures of the motion estimation 2 if the Levenberg-Marquardt method is used will be described by using FIG. 11. FIG. 11 is a flowchart for explaining another procedure of the motion estimation 2 according to the first embodiment. First, ξ with bar is substituted for ξ, and an initial value is set to ξ (S111). Subsequently, an initial value is set to λ (S112). Subsequently, g, H, and H* are calculated by using Equation (12), Equation (13), and Equation (32), respectively (S113).

Subsequently, g, H, and H* calculated at S113 are substituted in Equation (31), and the update amount Δξ of the camera attitude is calculated (S114). The projection errors E(ξ+Δξ) and E(ξ) are calculated and compared for ξ+Δξ and ξ, respectively (S115). If E(ξ+Δξ) is not smaller than E(ξ) (S115, Yes), the camera attitude ξ is not updated, and λ is multiplied by 10 times (S118). On the other hand, if E(ξ+Δξ) is less than E(ξ) (S115, No), the camera attitude ξ is updated by using the update amount Δξ calculated at S114 (S116), and λ is multiplied by 0.1 times (S117).

After λ is updated at S118 or S117, then, convergence determination of is made (S119). When the number of update times of ξ has reached the number of times set in advance or the set convergence condition is satisfied (S119, Yes), the parameter update processing is finished, and ξ at that point of time is made the estimation result (ξ with hat) (S120). The convergence determination at S120 is made by using Expression (14) or Expression (15) similarly to S105 in FIG. 7. On the other hand, if the number of update times of ξ has not reached the number of times set in advance and if the set convergence condition is not satisfied (S119, No), the routine returns to S113, and the parameter update processing is continued.

At S120, when the estimation result (ξ with hat) of the camera attitude is determined, the reliability of the estimation result is evaluated. The evaluation of the reliability (S121 to S123) is made by the procedure similar to S107 to S109 in FIG. 7. Both ξ with hat which is the motion estimation result and the reliability determination result by the reliability feature amount cf(ξ with hat) are outputted, and the series of procedures of the motion estimation 2 illustrated in FIG. 11 is finished.

As described above, when the motion estimation 2 is made by using the Levenberg-Marquardt method, too, whether the estimation result of the camera attitude in the motion estimation 2 is reliable or not is determined by calculating the reliability feature amount of the estimation result. When the reliability feature amount is to be acquired, E(ξ) in the neighborhood of ξ with hat is calculated by using Taylor developing and thus, the estimation result with high reliability can be calculated at a high speed.

Note that, in the above, in order to reduce a calculation amount of the reliability feature amount, E(ξ) in the neighborhood of ξ with hat is calculated by using Taylor developing, but the calculation amount of the reliability feature amount can be further reduced by calculating E(ξ) with 6 variables by regarding E(ξ) as 2-variable function E(ξᵢ, ξⱼ). Note that a component of ξ other than ξᵢ, ξⱼ is assumed to be equal to a corresponding component of ξ with hat. That is, ξₖ=ξₖ with hat (k≠i and k≠j).

With regard to the reliability feature amount, since cf(ξᵢ, ξⱼ)=cf(ξᵢ, ξⱼ) is established by definition, only either one of cf(ξᵢ, ξⱼ) and cf(ξᵢ, ξⱼ) needs to be calculated. For example, cf(ξᵢ, ξⱼ) is calculated for i≠j and i<j. More specifically, 15 reliability feature amounts, that is, cf(ξ₀, ξ₁), cf(ξ₀, ξ₂), cf(ξ₀, ξ₃), cf(ξ₀, ξ₄), cf(ξ₀, ξ₅), cf(ξ₁, ξ₂), cf(ξ₁, ξ₃), cf(ξ₁, ξ₄), cf(ξ₁, ξ₅), cf(ξ₂, ξ₃), cf(ξ₂, ξ₄), cf(ξ₂, ξ₅), cf(ξ₃, ξ₄), cf(ξ₃, ξ₅), and cf(ξ₄, ξ₅) are calculated.

Moreover, with regard to the calculation of E(ξᵢ, ξⱼ) for the neighboring point U(ξ with hat), fixed values Δξᵢ and Δξⱼ are determined in advance, and the calculation is carried out in four ways, that is, E(ξᵢ with hat+Δξᵢ, ξⱼ with hat+Δξⱼ), E(ξᵢ with hat−Δξᵢ, ξⱼ with hat+Δξⱼ), E(ξᵢ with hat+Δξᵢ, ξⱼ with hat−Δξⱼ), and E(ξᵢ with hat−Δξᵢ, ξⱼ with hat−Δξⱼ), for example.

When the reliability feature amount is to be calculated by using a ratio, cf(ξᵢ, ξⱼ) is calculated by the following Equation (33):

$$cf ( {\hat{ξ}}_{i} , {\hat{ξ}}_{j} ) = \frac{\begin{matrix}min ( E ( {\hat{ξ}}_{i} + Δ {ξ}_{i} , {\hat{ξ}}_{j} + Δ {ξ}_{j} ) , E ( {\hat{ξ}}_{i} - Δ {ξ}_{i} , {\hat{ξ}}_{j} + Δ {ξ}_{j} ) , \\ E ( {\hat{ξ}}_{i} + Δ {ξ}_{i} , {\hat{ξ}}_{j} - Δ {ξ}_{j} ) , E ( {\hat{ξ}}_{i} - Δ {ξ}_{i} , {\hat{ξ}}_{j} + Δ {ξ}_{j} ) )\end{matrix}}{E ( {\hat{ξ}}_{i} , {\hat{ξ}}_{j} )} \qquad Equation ( 33 )$$

Here, approximation calculation is carried out for E(ξᵢ with hat+Δξᵢ, ξⱼ with hat+Δξⱼ), E(ξᵢ with hat−Δξᵢ, ξⱼ with hat+Δξⱼ), E(ξᵢ with hat+Δξᵢ, ξⱼ with hat−Δξⱼ), and E(ξᵢ with hat−Δξᵢ, ξⱼ with hat−Δξⱼ) which are numerators of Equation (33) by the Taylor developed Equation (34). Moreover, Δξᵢ and Δξᵢ are assumed to be fixed values determined in advance.

$$E ( {\hat{ξ}}_{i} + Δ {ξ}_{i} , {\hat{ξ}}_{j} + Δ {ξ}_{j} ) ≅ E ( {ξ}_{i} , {ξ}_{j} ) + \frac{\partial E ( {ξ}_{i} , {ξ}_{j} )}{\partial {ξ}_{i}} Δ {ξ}_{i} + \frac{\partial E ( {ξ}_{i} , {ξ}_{j} )}{\partial {ξ}_{j}} Δ {ξ}_{j} + \frac{1}{2} \{ \frac{{\partial }^{2} E ( {ξ}_{i} , {ξ}_{j} )}{\partial {ξ}_{i}^{2}} {( Δ {ξ}_{i} )}^{2} + \frac{{\partial }^{2} E ( {ξ}_{i} , {ξ}_{j} )}{\partial {ξ}_{j}^{2}} {( Δ {ξ}_{j} )}^{2} + 2 \frac{{\partial }^{2} E ( {ξ}_{i} , {ξ}_{j} )}{\partial {ξ}_{i} \partial {ξ}_{j}} Δ {ξ}_{i} Δ {ξ}_{j} \} \qquad Equation ( 34 )$$

If the reliability feature amount is to be calculated by using a difference, cf(ξᵢ, ξⱼ) is calculated by Equation (35) shown below:

$$cf ( {\hat{ξ}}_{i} , {\hat{ξ}}_{j} ) = \frac{\begin{matrix}min ( E ( {\hat{ξ}}_{i} + Δ {ξ}_{i} , {\hat{ξ}}_{j} + Δ {ξ}_{j} ) , E ( {\hat{ξ}}_{i} - Δ {ξ}_{i} , {\hat{ξ}}_{j} + Δ {ξ}_{j} ) , \\ E ( {\hat{ξ}}_{i} + Δ {ξ}_{i} , {\hat{ξ}}_{j} - Δ {ξ}_{j} ) , E ( {\hat{ξ}}_{i} - Δ {ξ}_{i} , {\hat{ξ}}_{j} + Δ {ξ}_{j} ) ) - E ( {\hat{ξ}}_{i} , {\hat{ξ}}_{j} )\end{matrix}}{M} \qquad Equation ( 35 )$$

Here, approximation calculation is also carried out for E(ξᵢ with hat+Δξᵢ, ξⱼ with hat+Δξⱼ), E(ξᵢ with hat−Δξᵢ, ξⱼ with hat+Δξⱼ), E(ξᵢ with hat+Δξᵢ, ξⱼ with hat−Δξⱼ), and E(ξᵢ with hat−Δξᵢ, ξⱼ with hat−Δξⱼ) which are numerators of Equation (35) by the aforementioned Taylor developed Equation (34).

In the reliability determination, if cf(ξᵢ, ξⱼ) is larger than a threshold value Tᵢⱼ determined in advance for all the combinations of i and j, the estimation result ξ with hat is determined to be reliable. As described above, the calculation amount of the reliability feature amount can be further reduced by calculating E(ξ) with 6 variables by regarding E(ξ) as the 2-variable function E(ξᵢ, ξⱼ).

Note that the calculation amount of the reliability feature amount can be further reduced by calculating E(ξ) with 6 variables by regarding E(ξ) as a function E(ξᵢ) with 1 variable ξᵢ. At this time, a component of ξ other than ξᵢ is assumed to be equal to a corresponding component of ξ with hat. That is, ξₖ=ξₖ with hat (k≠i).

The calculation of E(ξᵢ) for the neighboring point U (ξ with hat) is performed in two ways, that is, E(ξᵢ with hat+Δξᵢ) and E(ξᵢ with hat−Δξᵢ) by determining a fixed value Δξᵢ in advance, for example.

When the reliability feature amount is to be calculated by using a ratio, cf(ξᵢ) is calculated by Equation (36) shown below:

$$cf ( {ξ}_{i} ) = \frac{min ( E ( {\hat{ξ}}_{i} + Δ {ξ}_{i} ) , E ( {\hat{ξ}}_{i} - {Δξ}_{i} ) )}{E ( {\hat{ξ}}_{i} )} \qquad Equation ( 36 )$$

Here, approximation calculation is carried out for E(ξᵢ with hat+Δξᵢ) and E(ξᵢ with hat−Δξᵢ) which are numerators of Equation (36) by the Taylor developed Equation (34). Moreover, Δξᵢ is assumed to be a fixed value determined in advance.

If the reliability feature amount is to be calculated by using a difference, cf(ξᵢ) is calculated by Equation (37) shown below:

$$E ( {ξ}_{i} + Δ {ξ}_{i} ) ≅ E ( {ξ}_{i} ) + \frac{\partial E ( {ξ}_{i} )}{\partial {ξ}_{i}} Δ ξ + \frac{1}{2} \frac{{\partial }^{2} E ( {ξ}_{i} )}{\partial {ξ}_{i}^{2}} {( Δ {ξ}_{i} )}^{2} \qquad Equation ( 37 )$$

Here, approximation calculation is also carried out for E(ξᵢ with hat+Δξᵢ) and E(ξᵢ with hat−Δξᵢ) which are numerators of Equation (37) by the aforementioned Taylor developed Equation (34).

In the reliability determination, if cf(ξᵢ) is larger than a threshold value Tᵢ determined in advance for all i (i=0, 1, . . . , 5), the estimation result ξ with hat is determined to be reliable. As described above, the calculation amount of the reliability feature amount can be further reduced by calculating E(ξ) with 6 variables by regarding E(ξ) as the 1-variable function E(ξᵢ).

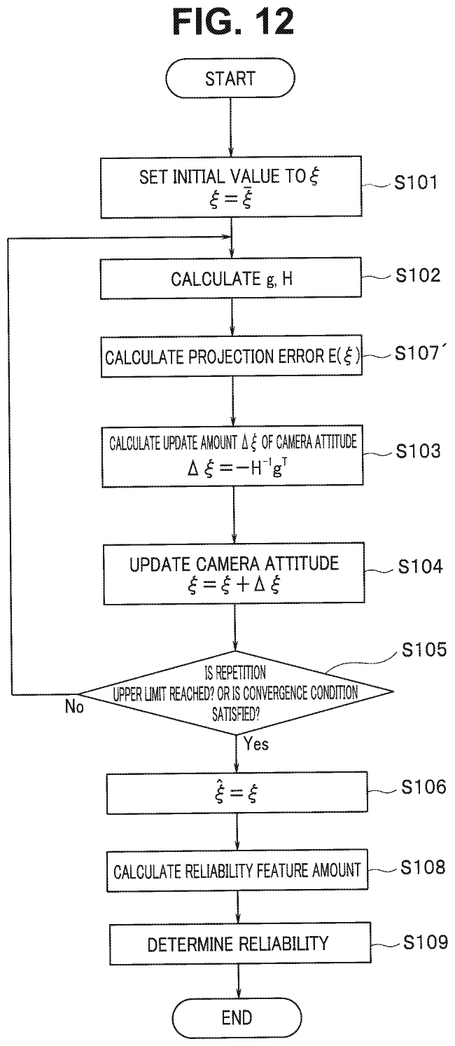

Subsequently, a variation in the embodiment will be described by using FIG. 12. FIG. 12 is a flowchart for explaining a series of procedures of the motion estimation 2 according to the variation of the first embodiment. In the estimation procedure of the camera attitude in the motion estimation 2 described by using FIG. 7, after the repeat calculation of the parameter is finished and the estimation result ξ with hat is determined, E(ξ with hat), g, and H are calculated in order to calculate the reliability feature amount (FIG. 7, S107). Since the calculation of g and H has been carried out in the repeat calculation (FIG. 7, S102), the procedure of calculating E(ξ with hat) after the estimation result ξ with hat is determined can be omitted by calculating also E(ξ) in the repeat calculation.

A more specific procedure of the motion estimation 2 in the variation will be described by using FIG. 12. First, similarly to the procedure in FIG. 7, ξ with bar is substituted for ξ, and an initial value is set to ξ (S101). Subsequently, g and H are calculated by using Equation (12) and Equation (13), respectively (S102). Subsequently, E(ξ) is calculated by using Equation (6) (S107′).

Subsequently, similarly to the procedure in FIG. 7, g and H calculated at S102 are substituted in Equation (11), and the update amount Δξ of the camera attitude is calculated (S103). Subsequently, the camera attitude ξ is updated by using the update amount Δξ calculated at S103 (S104), and convergence determination of ξ is performed (S105).

If the number of update times of has reached the number of times set in advance or if the set convergence condition is satisfied (S105, Yes), the parameter update processing is finished, and ξ at that point of time is made an estimation result (ξ with hat) (S106). On the other hand, if the number of update times of has not reached the number of times set in advance and if the set convergence condition is not satisfied (S105, No), the routine returns to S102, and the parameter update processing is continued.

Lastly, in the repeat calculation at S102 to S105, the reliability feature amount of the estimation result (ξ with hat) is calculated by using last calculated E(ξ), g, and H (S108). At this time, last calculated E(ξ) is made E(ξ with hat). The reliability is determined on the basis of the reliability feature amount calculated at S108 (S109), ξ with hat which is the motion estimation result and the reliability determination result by the reliability feature amount cf(ξ with hat) are outputted, and the series of procedures of the variation of the motion estimation 2 illustrated in FIG. 12 is finished.

As described above, the procedure of calculating E(ξ) separately for the calculation of the reliability feature amount can be omitted by calculating E(ξ) in the repeat procedure and by calculating the reliability feature amount by using last calculated E(ξ), g, and H, and the calculation amount can be reduced.

Note that in the above, the procedure of the variation of the motion estimation 2 using Gaussian and Newton's method as the algorithm used for the estimation of ξ is described by using FIG. 12, but even if the Levenberg-Marquardt method is used, the procedure of calculating E(ξ) separately for the calculation of the reliability feature amount can be omitted similarly.

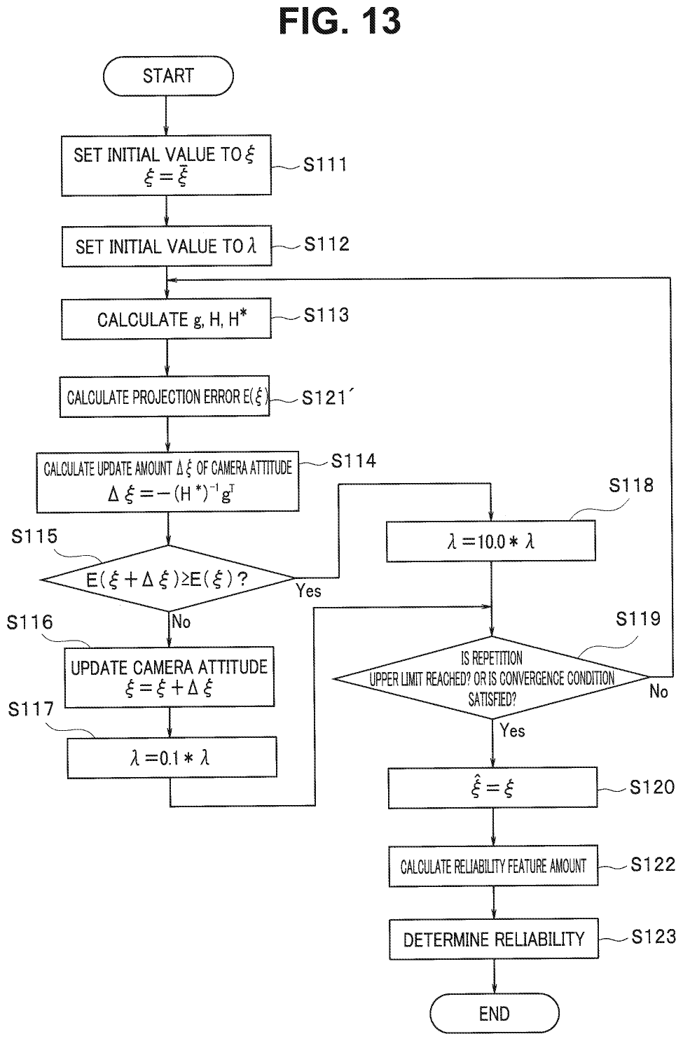

Hereinafter, the series of procedures of the motion estimation 2 in the variation when the Levenberg-Marquardt method is used will be described by using FIG. 13. FIG. 13 is a flowchart for explaining another procedure of the motion estimation 2 according to the variation of the first embodiment. First, similarly to the procedure illustrated in FIG. 11, ξ with bar is substituted for ξ, and an initial value is set to ξ (S11). Subsequently, an initial value is set to λ (S112). Subsequently, g, H, and H* are calculated by using Equation (12), Equation (13), and Equation (32), respectively (S113). Subsequently, E(ξ) is calculated by using Equation (6) (S121′).

Subsequently, similarly to the procedure in FIG. 11, g, H, and H* calculated at S113 are substituted in Equation (31), and the update amount Δξ of the camera attitude is calculated (S114). The projection errors E(ξ+Δξ) and E(ξ) are calculated and compared for ξ+Δξ and ξ, respectively, and if E(ξ+Δξ) is not smaller than E(ξ) (S115, Yes), the camera attitude ξ is not updated, and λ is multiplied by 10 times (S118). On the other hand, if E(ξ+Δξ) is less than E(ξ) (S115, No), the camera attitude ξ is updated by using the update amount Δξ0 calculated at S114 (S116), and λ is multiplied by 0.1 times (S117).

After λ is updated at S118 or S117, then, the convergence determination of is made (S119). When the number of update times of ξ has reached the number of times set in advance or the set convergence condition is satisfied (S119, Yes), the parameter update processing is finished, and ξ at that point of time is made the estimation result (ξ with hat) (S120). On the other hand, if the number of update times of ξ has not reached the number of times set in advance and the set convergence condition is not satisfied (S119, No), the routine returns to S113, and the parameter update processing is continued.

Lastly, in the repeat calculation at S113 to S119, the reliability feature amount of the estimation result (ξ with hat) is calculated by using last calculated E(ξ), g, and H (S122). At this time, lastly calculated E(ξ) is made E(ξ with hat). The reliability is determined on the basis of the reliability feature amount calculated at S122 (S123), ξ with hat which is the motion estimation result and the reliability determination result by the reliability feature amount cf(ξ with hat) are outputted, and the series of procedures of the variation of the motion estimation 2 illustrated in FIG. 13 is finished.

As described above, even when the Levenberg-Marquardt method is used, the procedure of calculating E(ξ) separately for the calculation of the reliability feature amount can be omitted by calculating E(i) in the repeat procedure and by calculating the reliability feature amount by using last calculated E(ξ), g, and H, and the calculation amount can be reduced.

### Second Embodiment

In the aforementioned first embodiment, the repeat calculation of the camera attitude ξ in the motion estimation 2 is determined to be converged when the set convergence condition (whether an average of the projection error per three-dimensional point is less than a threshold value set in advance or not or whether the value obtained by dividing an update amount of a parameter by a norm of an estimation parameter and by normalizing the result is less than the threshold value set in advance or not) is satisfied. On the other hand, in the embodiment, the reliability of the estimated value of the camera attitude ξ is evaluated in the repeat calculation, and if the reliability is high, the repeat calculation of the camera attitude in the motion estimation 2 is determined to be converged, which is a difference. Since configuration of the moving body control apparatus in the embodiment is similar to the first moving body control apparatus illustrated in FIGS. 1 to 4, description will be omitted.

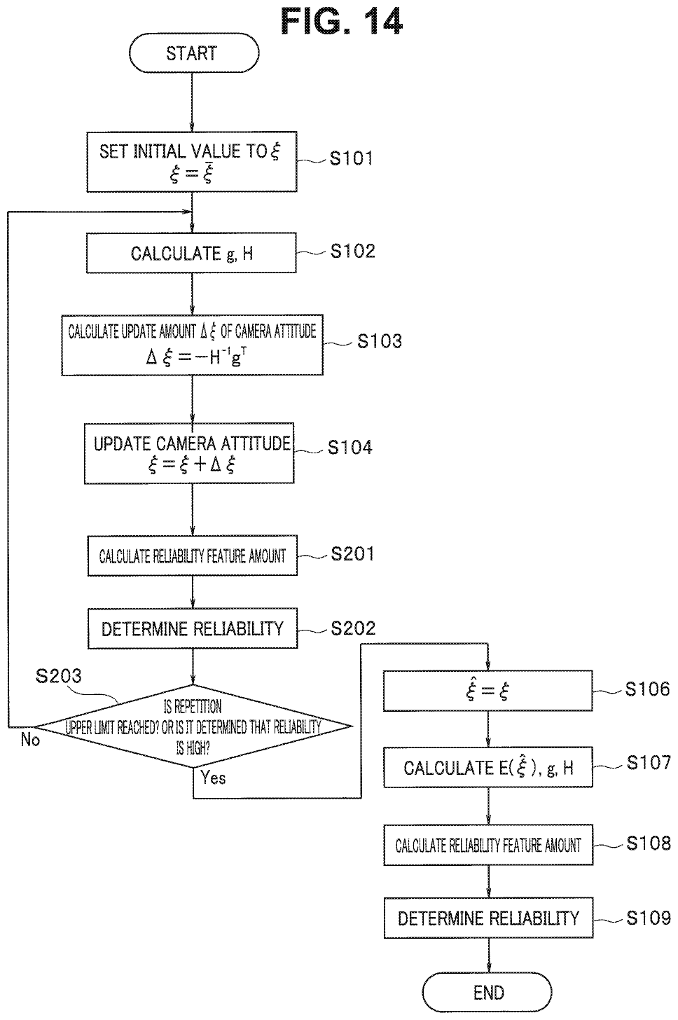

FIG. 14 is a flowchart for explaining a series of procedures of the motion estimation 2 according to the second embodiment. FIG. 14 illustrates a procedure when the motion estimation 2 is performed by using Gaussian Newton's method.

First, ξ with bar is substituted for ξ, and an initial value is set to (S101). Subsequently, g and H are calculated by using Equation (12) and Equation (13), respectively (S102). Subsequently, g and H calculated at S102 are substituted in Equation (11), and the update amount Δξ of the camera attitude is calculated (S103). Subsequently, the camera attitude ξ is updated by using the update amount Δξ calculated at S103 (S104). The procedure so far is quite similar to the procedure in the first embodiment described by using FIG. 7.

Subsequently, E(ξ) is calculated by using Equation (6), and the reliability feature amount of the camera attitude ξ is calculated together with g and H calculated at S102 (S201). Subsequently, the reliability is determined on the basis of the calculated reliability feature amount (S202).

If the number of update times of ξ has reached the number of times set in advance or if the reliability is determined to be high at S202 (S203, Yes), the parameter update processing is finished, and ξ at that point of time is made an estimation result (ξ with hat) (S106). On the other hand, if the number of update times of has not reached the number of times set in advance and if the reliability is determined to be low at S202 (S203, No), the routine returns to S102, and the parameter update processing is continued.

Lastly, the reliability of the estimation result (ξ with hat) of the camera attitude determined at S106 is evaluated (S107 to S109). Since the procedure at S107 to S109 is quite similar to the procedure in the first embodiment described by using FIG. 7, description will be omitted. Note that, if the reliability of the camera attitude ξ is determined to be high in the convergence determination at S203, the series of procedures of the reliability evaluation at S107 to S109 can be omitted.

As described above, according to the embodiment, the convergence determination in the repeat calculation for estimating the camera attitude is made on the basis of the reliability of the camera attitude. Therefore, since the estimation result with high reliability can be obtained, a frequency of stop of the moving body automatic control can be reduced, and convenience for the driver can be improved. Moreover, similarly to the first embodiment, when the reliability feature amount of the estimation result is to be acquired, E(ξ) in the neighborhood of ξ with hat is calculated by using Taylor developing and thus, the estimation result with high reliability can be calculated at a high speed. Furthermore, the automatic control of the moving body is continued only when the reliability is determined to be high, and if the reliability is determined to be low, the automatic control of the moving body is stopped, and the stop of the automatic control is notified to the driver. Therefore, the driver can easily recognize that the driver should operate the moving body by himself/herself and thus, the moving body can be controlled more safely.

Note that, in the above, the procedure using Gaussian Newton's method is described as an algorithm used for the estimation of ξ, but even when the Levenberg-Marquardt method is used, the motion estimation 2 in the embodiment can be performed similarly.

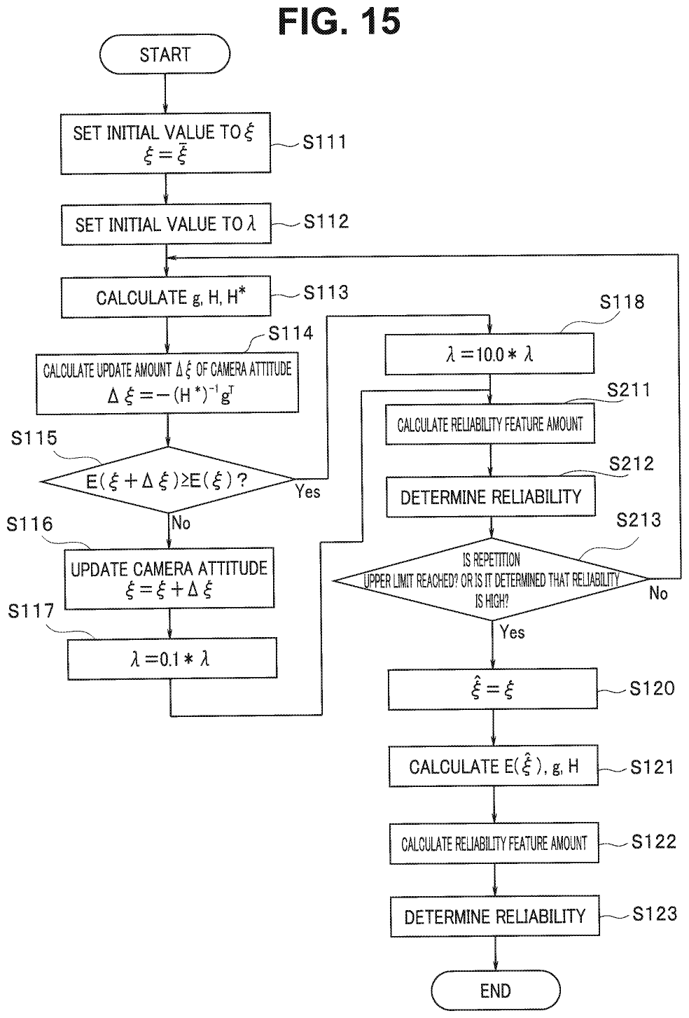

Hereinafter, the series of procedures of the motion estimation 2 in the second embodiment when the Levenberg-Marquardt method is used will be described by using FIG. 15. FIG. 15 is a flowchart for explaining another procedure of the motion estimation 2 according to the second embodiment.

First, ξ with bar is substituted for ξ, and an initial value is set to ξ (S11). Subsequently, an initial value is set to λ (S112). Subsequently, g, H, and H* are calculated by using Equation (12), Equation (13), and Equation (32), respectively (S113). Subsequently, g, H, and H* calculated at S113 are substituted in Equation (31), and the update amount Δξ of the camera attitude is calculated (S114). The projection errors E(ξ+Δξ) and E(ξ) are calculated and compared for ξ+Δξ and ξ, respectively, and if E(ξ+Δξ) is not smaller than E(ξ) (S115, Yes), the camera attitude ξ is not updated, and λ is multiplied by 10 times (S118). On the other hand, if E(ξ+Δξ) is less than E(ξ) (S115, No), the camera attitude ξ is updated by using the update amount Δξ calculated at S114 (S116), and λ is multiplied by 0.1 times (S117). The procedure so far is quite similar to the procedure in the first embodiment described by using FIG. 11.

After λ is updated at S118 or S117, E(ξ) is calculated by using Equation (6), and the reliability feature amount of the camera attitude ξ is calculated together with g and H calculated at S113 (S211). Subsequently, the reliability is determined on the basis of the calculated reliability feature amount (S212).

When the number of update times of ξ has reached the number of times set in advance or if the reliability is determined to be high at S212 (S213, Yes), the parameter update processing is finished, and ξ at that point of time is made the estimation result (ξ with hat) (S120). On the other hand, if the number of update times of ξ has not reached the number of times set in advance and the reliability is determined to be low at S212 (S213, No), the routine returns to S113, and the parameter update processing is continued.

Lastly, the reliability of the estimation result (ξ with hat) of the camera attitude determined at S120 is evaluated (S121 to S123). Since the procedure at S121 to S123 is quite similar to the procedure in the first embodiment described by using FIG. 11, description will be omitted. Note that, if the reliability of the camera attitude ξ is determined to be high in the convergence determination at S213, the series of procedures of the reliability evaluation at S121 to S123 can be omitted.

As described above, even when the Levenberg-Marquardt method is used, the estimation result with high reliability can be obtained by making the convergence determination in the repeat calculation for estimating the camera attitude on the basis of the reliability of the camera attitude. Therefore, the frequency of stop of the moving body automatic control can be reduced, and convenience for the driver can be improved.

Note that, in the embodiment, too, similarly to the variation of the first embodiment, the procedure of calculating E(ξ) separately for calculating the reliability feature amount after the estimation result (ξ with hat) of the camera attitude is calculated can be omitted by calculating E(ξ) in the repeat procedure of the parameter estimation and by calculating the reliability feature amount by using last calculated E(ξ), g, and H.

Moreover, similarly to the first embodiment, in the calculation of the reliability feature amount, E(ξ) with 6 variables can be calculated by regarding E(ξ) as the function E(ξᵢ, ξⱼ) with 2 variables or the function E(ξᵢ) with 1 variable ξᵢ.

### Third Embodiment

In the first and second embodiments, the convergence determination of the repeat calculation of the camera attitude ξ in the motion estimation 2 is made on the basis of information (image information) obtained from the camera which is an external sensor, but in the third embodiment, the convergence determination is made on the basis of vehicle information obtained from a vehicle sensor which is an internal sensor, which is a difference.

Configuration of the moving body control apparatus in the embodiment is similar to the first moving body control apparatus illustrated in FIGS. 1 to 4, but the sensor 100B includes the vehicle sensor as an internal sensor. The vehicle information is inputted from the vehicle sensor to the image processing device 10. The vehicle information is data obtained from the vehicle sensor and is a rotation amount of a turning motion of the vehicle obtained from a yaw rate sensor, for example. As the rotation amount, more specifically, a change of the yaw angle Δα_{yaw}(t, t−1) between the time t and t−1 is obtained.

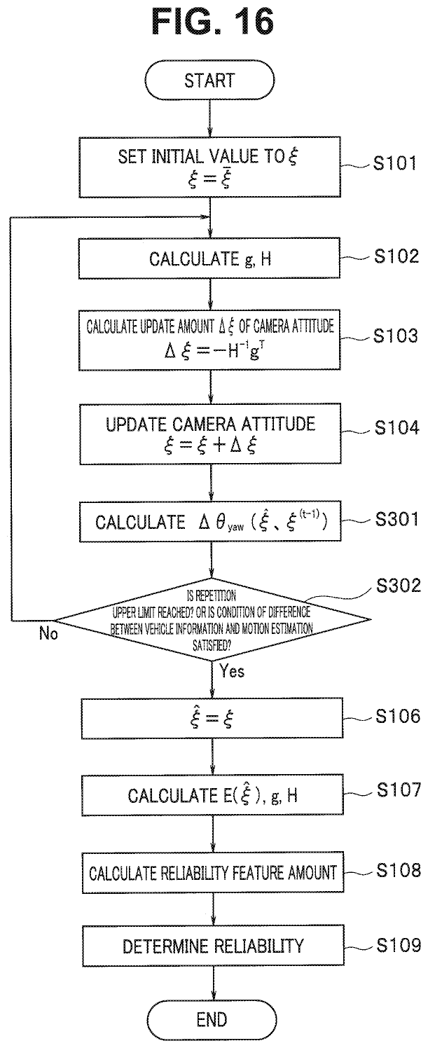

FIG. 16 is a flowchart for explaining a series of procedures of the motion estimation 2 according to the third embodiment. FIG. 16 illustrates the procedure when the motion estimation 2 is performed by using Gaussian Newton's method.

First, ξ with bar is substituted for ξ, and an initial value is set to ξ (S101). Subsequently, g and H are calculated by using Equation (12) and Equation (13), respectively (S102). Subsequently, g and H calculated at S102 are substituted in Equation (11), and the update amount Δξ of the camera attitude is calculated (S103). Subsequently, the camera attitude ξ is updated by using the update amount Δξ calculated at S103 (S104). The procedure so far is totally similar to the procedure in the first embodiment described by using FIG. 7.

Subsequently, Δθ_{yaw}(ξ, ξ^{(t-1)}) which is a change in a yaw angle between the estimated value ξ of the camera attitude of the frame t and the estimation result ξ^{(t-1)} with hat of the camera attitude of the frame t−1 is calculated (S301). When the number of update times of ξ has reached the number of times set in advance or if a difference between the change of yaw angle Δα_{yaw}(t, t−1) obtained from the yaw rate sensor and the change of yaw angle Δθ_{yaw}(ξ, ξ^{(t-1)}) calculated at S301 is less than a threshold value (T_{yaw}) set in advance (S302, Yes), the parameter update processing is finished, and ξ at the point of time is made the estimation result (ξ with hat) (S106).

On the other hand, if the number of update times of ξ has not reached the number of times set in advance and if the difference between Δα_{yaw}(t, t−1) and Δθ_{yaw}(ξ, ξ^{(t-1)}) is not smaller than a threshold value (T_{yaw}) set in advance (S302, No), the routine returns to S102, and the parameter update processing is continued.

Lastly, the reliability of the estimation result (ξ with hat) of the camera attitude determined at S106 is evaluated (S107 to S109). Since the procedure at S107 to S109 is quite similar to the procedure in the first embodiment described by using FIG. 7, description will be omitted.

As described above, according to the embodiment, the convergence determination in the repeat calculation for estimating the camera attitude is made by using the vehicle information obtained from the vehicle sensor or by using the change in the yaw angle obtained from the yaw rate sensor, for example. By checking the estimation of the camera attitude on the basis of the information of different sensors, the estimation result with high reliability can be obtained. Moreover, similarly to the first embodiment, when the reliability feature amount of the estimation result is to be acquired, E(ξ) in the neighborhood of ξ with hat is calculated by using Taylor developing and thus, the estimation result with high reliability can be calculated at a high speed. Furthermore, the automatic control of the moving body is continued only when the reliability is determined to be high, and if the reliability is determined to be low, the automatic control of the moving body is stopped, and the stop of the automatic control is notified to the driver. Therefore, the driver can easily recognize that the driver should operate the moving body by himself/herself and thus, the moving body can be controlled more safely.

Note that, in the above, the procedure using Gaussian Newton's method is described as an algorithm used for the estimation of ξ, but even when the Levenberg-Marquardt method is used, the motion estimation 2 in the embodiment can be performed similarly.

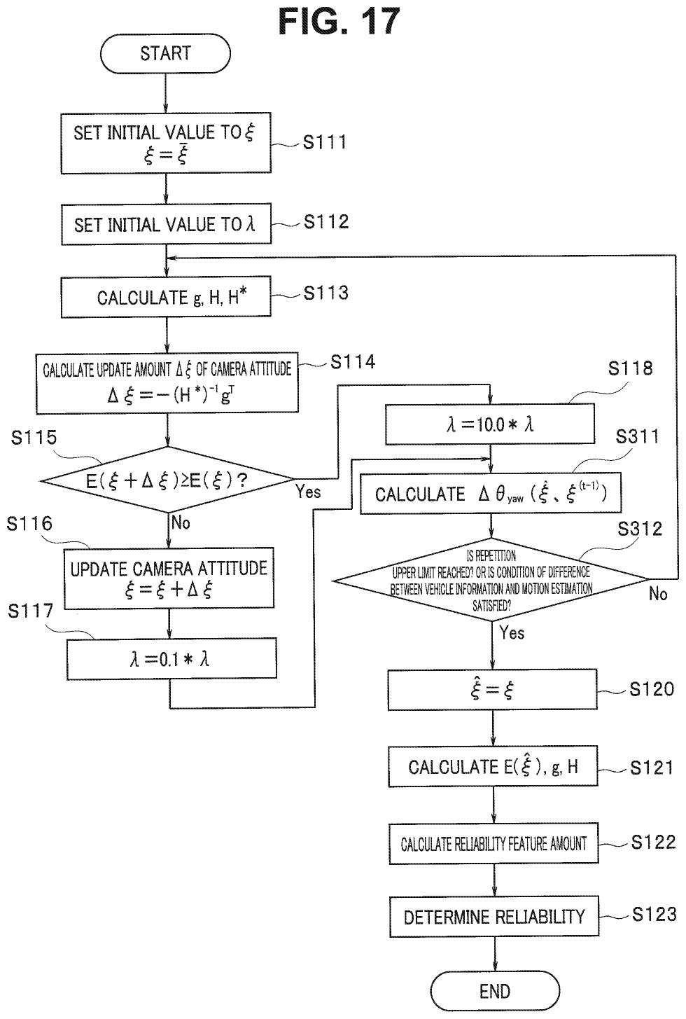

Hereinafter, the series of procedures of the motion estimation 2 in the second embodiment when the Levenberg-Marquardt method is used will be described by using FIG. 17. FIG. 17 is a flowchart for explaining another procedure of the motion estimation 2 according to the third embodiment.

First, ξ with bar is substituted for ξ, and an initial value is set to ξ(S111). Subsequently, an initial value is set to λ (S112). Subsequently, g, H, and H* are calculated by using Equation (12), Equation (13), and Equation (32), respectively (S113). Subsequently, g, H, and H* calculated at S113 are substituted in Equation (31), and the update amount Δξ of the camera attitude is calculated (S114). The projection errors E(ξ+Δξ) and E(ξ) are calculated and compared for ξ+Δξ, and ξ, respectively, and if E(ξ+Δξ) is not smaller than E(ξ) (S115, Yes), the camera attitude ξ is not updated, and λ is multiplied by 10 times (S118). On the other hand, if E(ξ+Δξ) is less than E(ξ) (S115, No), the camera attitude ξ is updated by using the update amount Δξ calculated at S114 (S116), and λ is multiplied by 0.1 times (S117). The procedure so far is quite similar to the procedure in the first embodiment described by using FIG. 11.

After λ is updated at S118 or S117, Δθ_{yaw}(ξ, ξ^{(t-1)}) which is a change in a yaw angle between the estimated value ξ of the camera attitude of the frame t and the estimation result ξ^{(t-1)} with hat of the camera attitude of the frame t−1 is calculated (S311). When the number of update times of ξ has reached the number of times set in advance or if a difference between the change of yaw angle Δθ_{yaw}(t, t−1) obtained from the yaw rate sensor and the change of yaw angle Δθ_{yaw}(ξ, ξ^{(t-1)}) calculated at S311 is less than the threshold value (T_{yaw}) set in advance (S312, Yes), the parameter update processing is finished, and ξ at the point of time is made the estimation result (ξ with hat) (S120).

On the other hand, if the number of update times of ξ has not reached the number of times set in advance and if the difference between Δα_{yaw}(t, t−1) and Δθ_{yaw}(ξ, ξ^{(t-1)}) is not smaller than a threshold value (T_{yaw}) set in advance (S312, Yes), the routine returns to S113, and the parameter update processing is continued.

Lastly, the reliability of the estimation result (ξ with hat) of the camera attitude determined at S120 is evaluated (S121 to S123). Since the procedure at S121 to S123 is quite similar to the procedure in the first embodiment described by using FIG. 11, description will be omitted.

As described above, even when the Levenberg-Marquardt method is used, the convergence determination in the repeat calculation for estimating the camera attitude is made by using the vehicle information obtained from the vehicle sensor or by using the change in the yaw angle obtained from the yaw rate sensor, for example. By checking the estimation of the camera attitude on the basis of the information of different sensors, the estimation result with high reliability can be obtained. Therefore, the frequency of stop of the moving body automatic control can be reduced, and convenience for the driver can be improved.

While certain embodiments have been described, these embodiments have been presented by way of example only, and are not intended to limit the scope of the inventions. Indeed, the novel devices and systems described herein may be embodied in a variety of other forms; furthermore, various omissions, substitutions and changes in the form of the devices and systems described herein may be made without departing from the spirit of the inventions. The accompanying claims and their equivalents are intended to cover such forms or modifications as would fall within the scope and spirit of the inventions.

What is claimed is:

1. A moving body control apparatus comprising:
an image processing device configured to estimate an attitude of an image pickup device on the basis of a photographed image obtained by the image pickup device provided on a moving body and to output the attitude as an estimation result; and
a power control portion configured to control a power portion provided on the moving body on the basis of the estimation result, wherein
the image processing device includes a reliability feature amount calculating portion configured to calculate a reliability feature amount of the estimation result and a reliability determining portion configured to determine reliability of the estimation result on the basis of the reliability feature amount; and
the power control portion determines whether automatic control of the power portion is executed or not on a basis of a determination result of the reliability.

2. The moving body control apparatus according to claim 1, wherein
if a determination result of the reliability is low, the power control portion stops automatic control of the power portion, and the image processing device causes a display provided on the moving body to display that the power control portion does not execute the automatic control of the power portion.

3. The moving body control apparatus according to claim 1, wherein
the image processing device uses a projection error as an objective function for estimating an attitude of the image pickup device and calculates a value of the objective function in a neighborhood of the estimation result by using Taylor developing.

4. The moving body control apparatus according to claim 3, wherein
the image processing device calculates a value of the objective function by using a Gaussian Newton's method.

5. The moving body control apparatus according to claim 3, wherein
the image processing device calculates a value of the objective function by using a Levenberg-Marquardt method.

6. The moving body control apparatus according to claim 3, wherein
the image processing device calculates a value of the objective function by regarding a part of variables in the plural variables of the objective function as a fixed value.

7. The moving body control apparatus according to claim 3, wherein
the image processing device calculates the reliability feature amount by using a value of the objective function last calculated in estimation of an attitude of the image pickup device, a gradient vector of the objective function, and Hessian matrices of the objective function.

8. The moving body control apparatus according to claim 1, wherein
the image processing device repeatedly estimates an attitude of the image pickup device until a reliability feature amount of the estimation result becomes higher than a set value.

9. The moving body control apparatus according to claim 1, wherein
the image processing device repeatedly estimates an attitude of the image pickup device until a difference between vehicle information obtained from a vehicle sensor provided on the moving body and an estimated value of the attitude of the image pickup device becomes smaller than a set value.

10. The moving body control apparatus according to claim 9, wherein
the vehicle sensor is a yaw rate sensor, and the vehicle information is a yaw angle.
